(19) United States
(12) Patent Application Publication
(10) Pub. No.: US 2016/0023366 A1
(43) Pub. Date: Jan. 28, 2016

(54) METHOD AND APPARATUS FOR AUTOMATED CREATION OF RIGID FRAMED IMAGES

(71) Applicant: Michael Kane, Newport Beach, CA (US)

(72) Inventor: Michael Kane, Newport Beach, CA (US)

(21) Appl. No.: 14/168,282

(22) Filed: Jan. 30, 2014

(51) Int. Cl. B26D 3/06; B26D 3/08; A47G 1/06; B41M 3/00; G06F 17/22

(52) U.S. Cl. CPC B26D 3/065; B41M 3/00; G06F 17/2247; A47G 1/06; B26D 3/085

(57) ABSTRACT

Method and apparatus for fabricating a rigid framed image wherein an image is received in an electronic form. The image is then associated with a frame template to form a virtualized framed image. A cut directive is created in association with a printer directive so that the image is imparted onto a substrate on one side and grooves are cut into the opposite side of the substrate so that the substrate can subsequently be formed into a three dimensional picture frame.

### BACKGROUND

It is a very time consuming task to mount a picture in a frame. There are many different styles of frames, but no matter what style is used to frame a picture the resulting framed picture is a costly item. It is not necessarily the materials that contribute to the cost of a framed picture, but rather it is the labor associated with the mounting of an image onto a canvas and the construction of a frame. Using traditional materials, for example wood or metal, a picture frame is typically formed using linear members having their ends mitered and joined together in a substantially permanent manner. Once the picture frame is created, the image needs to be imparted onto canvas and the canvas then must be conformed to the picture frame.

Some picture frames are actually quite simplistic. One example of such a simplistic frame is known as the gallery wrap. A gallery wrap frame is sort of a “no nonsense” picture frame made from simple wood. A canvas is wrapped around the front of the frame back to the rear of the frame and fastened into place.

As with other types of products, the sales and ordering of a framed picture has been somewhat automated using modern Internet techniques. For example, there are internet based websites that allow a user to upload an image. The image is then imparted onto canvas based on certain size constraints specified by the user when the image is uploaded. In essence, this is no more than just a job request. In response to this job request, artisans then create a frame and a printer is used to print the image onto a canvas. Once the image is on the canvas and the frame has been prepared, then an artisan still needs to fix the canvas into the frame. As such, the finished product is then shipped to the customer. Again, it is important to note that even though the order process is automated through the use of modern Internet techniques, skilled artisans are still required to prepare the frame and to fix the canvas into the frame. Accordingly, the amount of labor involved in preparing the framed image is not substantially reduced.

Recently, a framed picture can be realized by imparting the image onto a substrate. In one example, the substrate comprises air-filled material having a more than nominal thickness. In this realm, an air filled material may include Styrofoam and that air filled material is then sandwiched between a first and second surface. Accordingly, an image may be imparted upon either the first or second surface of the substrate. Once the image is imparted on to the substrate, scoring, or rabbiting, is performed on the rear of the substrate. Then, the substrate can be folded all along the rabbits to form a three-dimensional picture frame where the picture frame is integral with the canvas upon which an image is imparted. To realize this type of picture framing, it is first necessary to print the image onto the substrate. Then, some process needs to be employed in order to specify the scoring to be applied to the rear surface of the substrate.

Even though the use of such modern materials appears to have some cost benefit because the canvas is now integral with the material that forms the frame, this process still requires the skill of an artisan to specify the location on the substrate that the image should be printed on. A skilled artisan is also needed to specify the scoring required to realize a three-dimensional picture frame. It should be appreciated that such a picture frame can constitute various styles of picture frames including the aforementioned gallery wrap. Other three dimensional picture frame shapes can also be realized.

Even when combined with a website based mechanism for receiving an image in electronic form, the use of a substrate of more than nominal thickness for both the frame material and the canvas does not eliminate the need for an artisan to actually specify the scoring and placement of the image on a canvas.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for automatically creating a rigid framed image;

FIG. 2 is a flow diagram that depicts one example alternative method for receiving a first image in electronic form;

FIG. 3 is a flow diagram that depicts one example alternative method for generating a printing script that includes a job identifier;

FIG. 4 is a flow diagram that depicts one alternative example method for generating a printing script that includes a cut directive;

FIG. 5 is a flow diagram that depicts one alternative method for generating a printing script that includes a cut directive based on a first frame template and a first image;

FIG. 6 is a flow diagram that depicts one example alternative method for cutting grooves in the rear surface of a substrate according to registration directive;

FIGS. 7A and 7B constitute a flow diagram that depict one alternative example method for associating a second image and a second style directive with an area to be printed on a substrate;

FIG. 8 is a block diagram that illustrates one example system for fabricating a rigid framed image;

FIGS. 9A and 9B are pictorial diagrams that depict a substrate that as been fashioned into a rigid framed image;

FIG. 10 is a block diagram that depicts the internal structure of an image processing subsystem;

FIG. 11 is a dataflow diagram that depicts the internal operation of an image processing subsystem;

FIG. 12 is a pictorial representation that depicts how images are imparted upon a substrate;

FIG. 13 is a block diagram that depicts an example alternative of embodiment of an image reception interface;

FIG. 14 is a dataflow diagram that depicts the operation of one alternative example embodiment of an image reception interface;

FIG. 15 is a block diagram that depicts one example embodiment of the substrate rabbetting subsystem; and

FIG. 16 is a dataflow diagram that depicts the operation of one example embodiment of a rabbetting subsystem.

### DETAILED DESCRIPTION

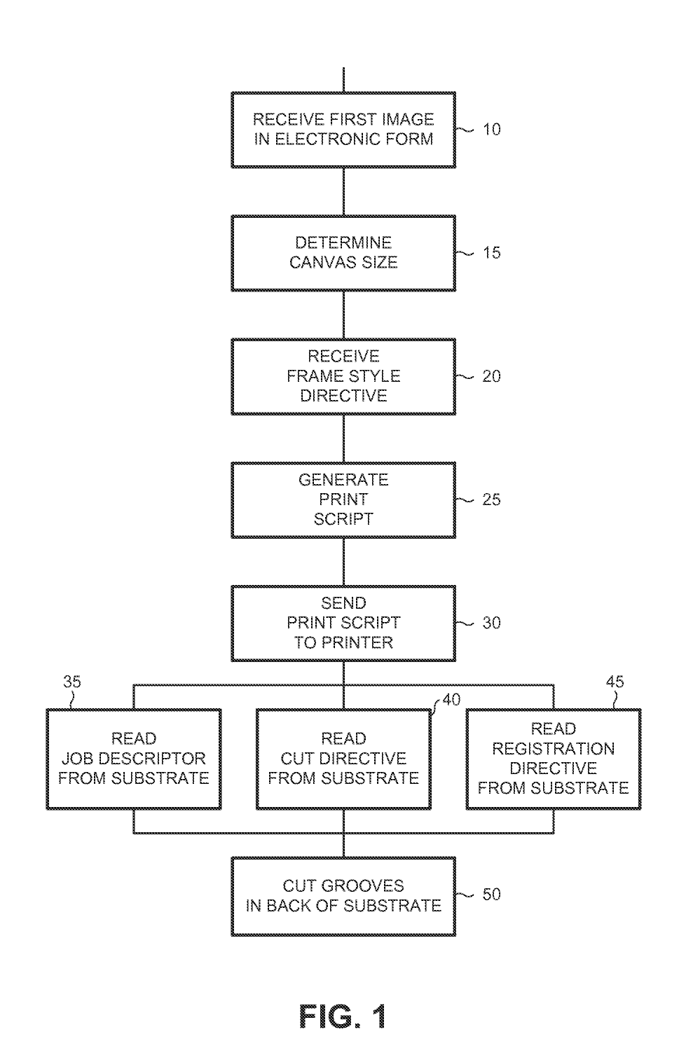

FIG. 1 is a flow that depicts one example method for automatically creating a rigid framed image. In this example method, a first image is received in electronic form (step 10). In an optional step, a canvas size is determined (step 15) according to the size of the first image received in such electronic form. It should be appreciated that, according to one alternative example method, the size of a canvas is determined by receiving a canvas size directive from a user. In yet another alternative method, the size of the canvas is determined by receiving a zoom factor for the image, said zoom factor being specified by a user when the electronic image is uploaded into a system for automatically creating a rigid framed image.

According to this example illustrative method, a frame style directive is also received (step 20). It should be appreciated that a frame style directive is typically received from a user. The frame style directive is then associated with the image as received in electronic form. With this information, a print script is generated (step 25). Once the print script is created, it is sent to a printer (step 30).

In this example method, the print script is generated according to the first image received in electronic form and the first frame style directive. The print script in this example method also includes at least one of a job descriptor, a cut directive and a placement directive. For example, a job descriptor comprises an identifier for a job definition, which is typically stored in computer readable medium. The job definition in this example method comprises additional information necessary to specify scoring on the rear, or second surface of a substrate. It should be appreciated that printing occurs on a first, or front surface of the substrate. In this case, the print directive includes the image which is then imparted to the front surface of the substrate during the printing process.

In this example method, further processing of the substrate is accomplished after the image is imparted to the front surface of the substrate. Said further processing includes scoring of the rear surface of the substrate in order to create break lines which allow the printed substrate to be formed into a three-dimensional framed image. It should be appreciated that, according to this example method, information for scoring the rear surface of the substrate is obtained by reading at least one of a job descriptor, a cut directive and a registration directive from the image imparted to the front surface of the substrate during the printing process. In one alternative method where a job descriptor is read from the substrate (step 35), the job descriptor is used to retrieve scoring information from a computer readable medium. The retrieved scoring information is then use to control a scoring mechanism in order to create break lines in the rear surface of the substrate.

In yet another alternative method where a cut directive is read from the substrate (step 40), the cut directive is used to directly control the scoring mechanism in order to create break lines in the rear surface of the substrate. It should be appreciated that the cut directive includes specific scoring information use to directly control a scoring mechanism. In either of these alternative example methods, grooves, or rabbets are then cut into the back of the substrate (step 50) according to at least one scoring information retrieved from computer readable medium using the job descriptor and the cut directive imparted upon the substrate during the printing process.

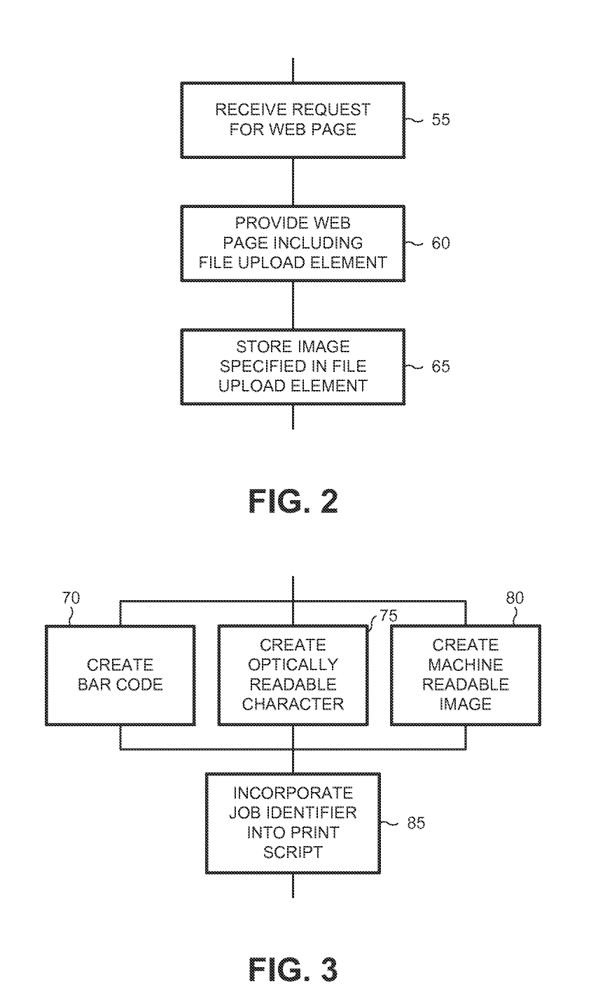

FIG. 2 is a flow diagram that depicts one example alternative method for receiving a first image in electronic form. According to this example alternative method, a first image is received by first receiving a request for a web page (step 55). It should be appreciated that such a request for a web page is typically received in a web server. In response, a web page is then provided (step 60). In this alternative example method, the web page that is provided in response to the request includes a file uploaded element. Once the web page is presented to a user, the user uses the file uploaded element included in the web page definition in order to specify a file stored on computer readable medium, said file having encoded therein a first image. In this alternative example method, the image is then received when the user submits the specified file and said image is then stored (step 65).

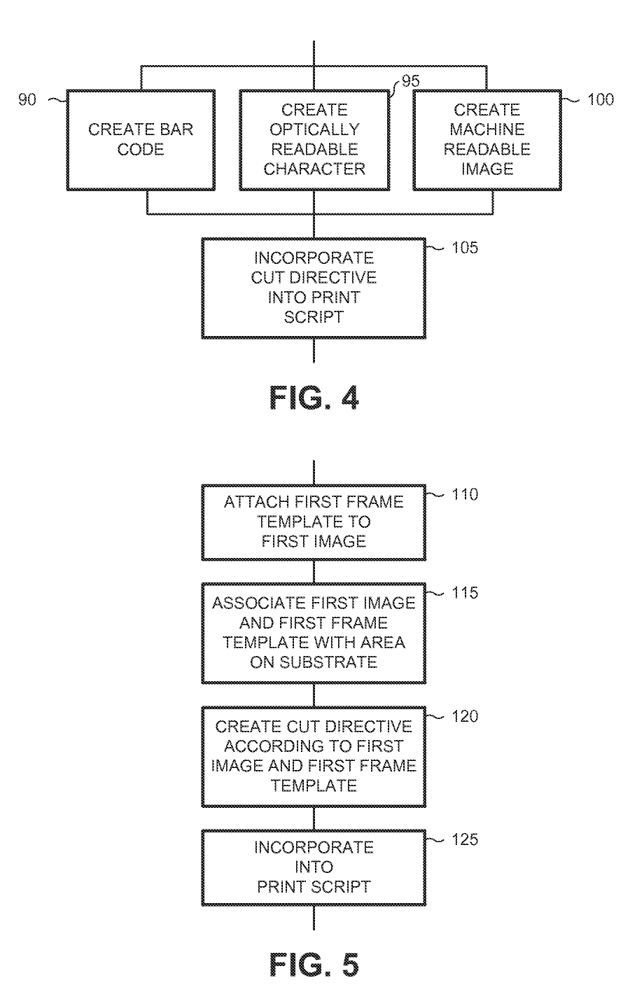

FIG. 3 is a flow diagram that depicts one example alternative method for generating a printing script that includes a job identifier. In this alternative example method, a printing script is generated by including a print definition in the form of a machine readable image (step 80). It should be appreciated that, according to one alternative example method, the printing script is generated by including a print definition for a bar-code (step 70). And in yet another alternative example method, the print script is generated by a including a definition for an optically readable character (step 75) in the printing script. It should be appreciated that, in the overall process, at least one out of a bar-code, an optically readable character, and any suitable machine readable image is then imparted to the front surface of a substrate by a printer according to a printing script directed to said printer. In this alternative example method, at least one of the bar-code, the optically readable character and any suitable machine readable image are generated according to the job identifier giving effect to incorporating the job identifier into the print script (step 85).

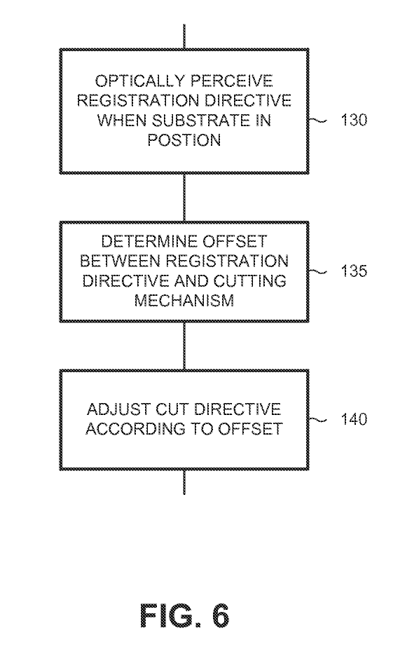

FIG. 4 is a flow diagram that depicts one alternative example method for generating a printing script that includes a cut directive. In this alternative example method, a printing script is generated by including a cut directive in the form of a machine readable image (step 100). It should be appreciated that, according to one alternative example method, the printing script is generated by including a print definition for a bar-code (step 90). And in yet another alternative example method, the print script is generated by a including a definition for an optically readable character (step 95) in the printing script. It should be appreciated that, in the overall process, at least one out of a bar-code, an optically readable character, and any suitable machine readable image is then imparted to the front surface of a substrate by a printer according to a printing script directed to said printer. In this alternative example method, at least one of the bar-code, the optically readable character and any suitable machine readable image are generated according to a out directive giving effect to incorporating the cut directive into the print script (step 105).

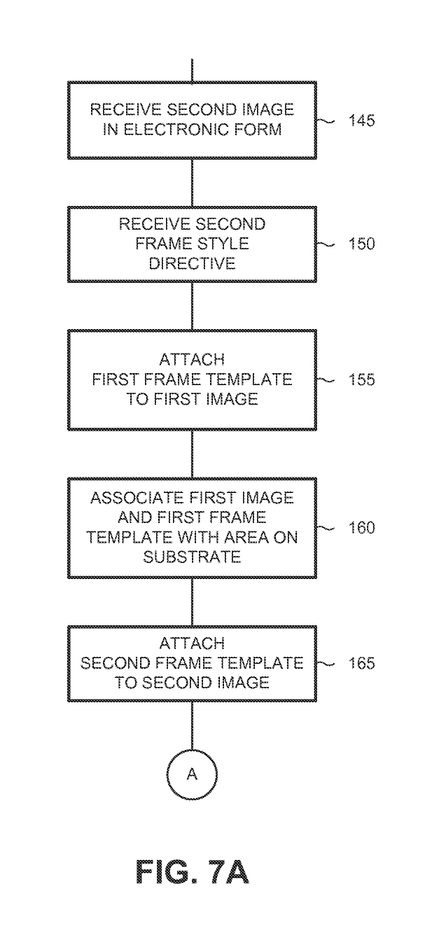

FIG. 5 is a flow diagram that depicts one alternative method for generating a printing script that includes a cut directive based on a first frame template and a first image. It should be appreciated that, according to this alternative example method, the first frame template is attached to a first image (step 110). In this alternative example method, a frame template is selected according to a first frame style directive, which is typically received substantially contemporaneously with the reception of an image in electronic form. Accordingly, the first image and the first frame template are then associated with an area of the first surface of the substrate (step 115). It should be appreciated that this area defines where the first image and its associated first frame template are to be printed on the front surface of the substrate. In this alternative example method, a cut directive is created (step 120) for the composite of the first image and the first frame template. The cut directive is then offset so that the first image and a first frame template are situated in the substrate area associated with said first image and first frame template. As such, the cut directive, as subject to the offset, is then incorporated into the printing script (step 125).

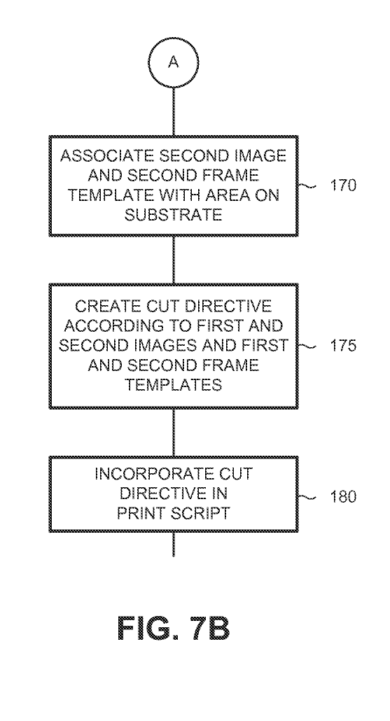

FIG. 6 is a flow diagram that depicts one example alternative method for cutting grooves in the rear surface of a substrate according to registration directive. According to this alternative example method, to registration directive is optically perceived (step 130) from the substrate when the substrate is in position to be scored on its rear surface. In this example alternative method, an offset is determined to between the registration directive and a cutting mechanism which is used to score the rear surface of the substrate (step 135). It should be appreciated that when a substrate having an image imparted thereon is placed in an apparatus for scoring the rear surface of the substrate, there is likely to be some offset between a cutting mechanism included in said apparatus and an image imparted to the substrate. Accordingly, once the registration directive is perceived in an optical manner, an offset can be ascertained. This offset, according to this alternative example method, is applied to a cut directive (step 140). As such, the adjusted cut directive is then used to impart scoring to the rear surface of the substrate.

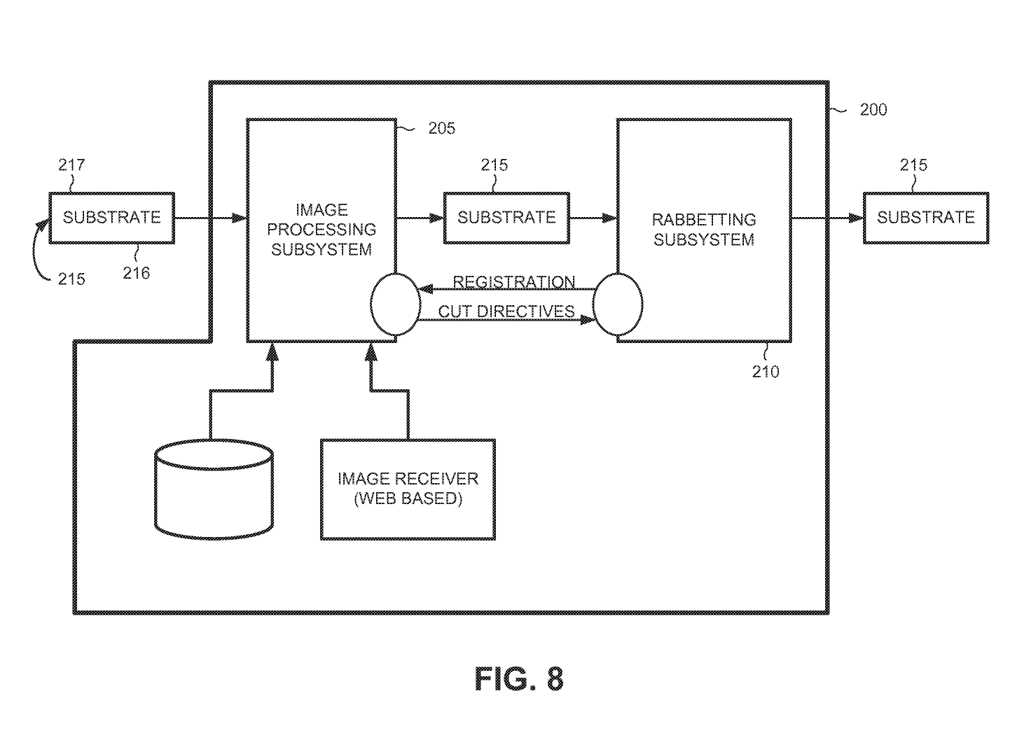

FIGS. 7A and 7B constitute a flow diagram that depict one alternative example method for associating a second image and a second style directive with an area to be printed on a substrate. According to one alternative example method, creation of a rigid framed image in an automatic manner further comprises receiving a second image in electronic form (step 145). A second frame style directive is also received (step 150). As in the base method described before, the first frame template is attached to a first image (step 155). The first image and a first frame template are associated with an area on the substrate (step 160). It is within this area on the substrate that the first image and the first frame template will be imparted by a printing process.

In furtherance of the present example alternative method, a second frame template is attached to the second image (step 165). The second image in the second frame template are then associated with the same area on the substrate (step 170). A cut directive is then created according to the first and second images and the first and second frame templates (step 175). It should be appreciated that the cut directive is offset according to the location of the area on said substrate. The cut directive is then incorporated into a printing script (step 180). It is to be appreciated that the cut directive as incorporated into the print script comprises at least one of a bar-code, an optically readable character and any suitable machine readable image as per the teachings of the present method.

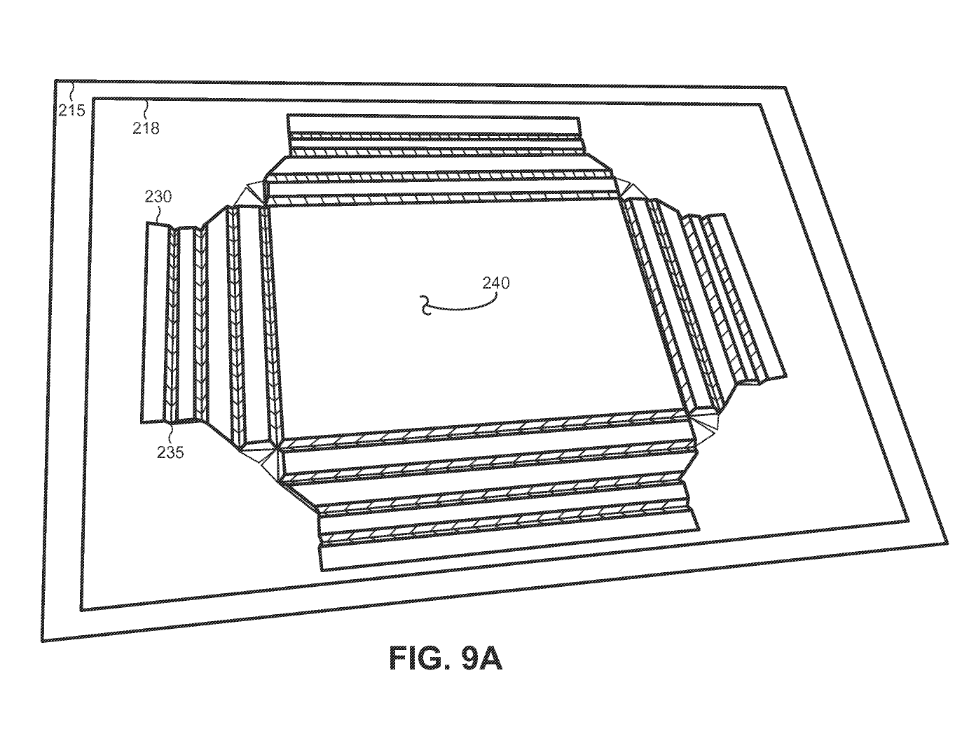

FIG. 8 is a block diagram that illustrates one example system for fabricating a rigid framed image. In this example embodiment, a system 200 for fabricating a rigid framed image comprises an image processing subsystem 205 and a rabbetting subsystem 210. In this system 200, the image processing subsystem 205 receives a substrate 215. In the course of normal operation, the image processing subsystem 205 will impart an image onto the substrate 215. It should be particularly noted that the substrate 215 has a first side 216 and a second side 217. In this example embodiment, the image processing subsystem 205 imparts an image onto the first side 216 of the substrate 215. The rabbetting subsystem 210 rabbets the second side 217 of the substrate 215. As the image processing subsystem completes its role of imparting an image upon the substrate 215 the substrate 215 then moves to the rabbetting subsystem 210. After the rabbets are cut into the substrate 215, then the substrate 215 can be formed into a rigid framed image by simply folding the substrate along the rabbets.

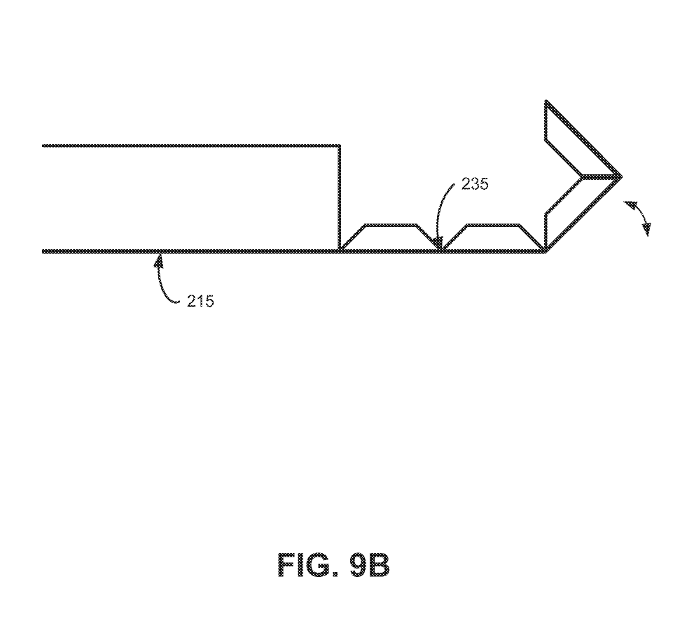

FIGS. 9A and 9B are pictorial diagrams that depict a substrate that has been fashioned into a rigid framed image. In these figures, a substrate 215 has an area 218 within which the framed image is disposed. The framed image 230 includes a plurality of rabbets 235. The rabbets 235 are then used as demarcations for folding the substrate 215 in manner so as to form a framed image. It should be appreciated that the center area 240 of the framed image 230 is where a first image is actually imparted onto the substrate. In FIG. 9A, the rabbets are cut into the second, or rear side of the substrate 215. The image is imparted onto the front, or first side of the substrate. As shown in FIG. 9B, the rabbets 235 provide relief so that the substrate 215 can be folded into a three dimensional picture frame.

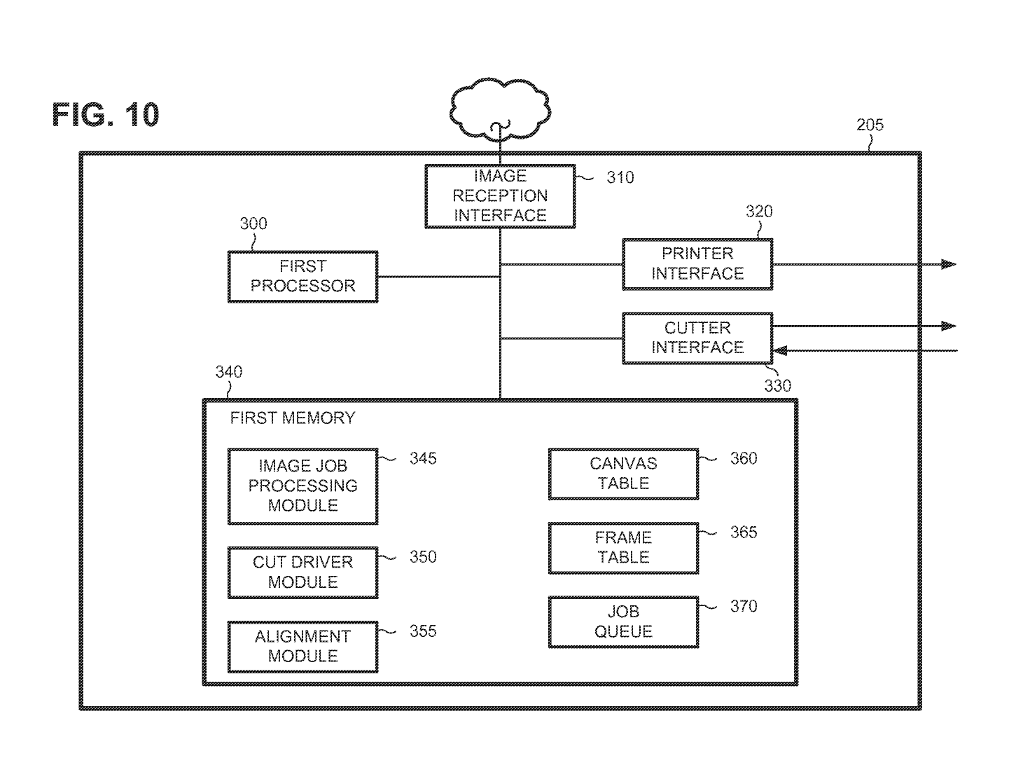

FIG. 10 is a block diagram that depicts the internal structure of an image processing subsystem. In this example embodiment, the image processing subsystem comprises a first processor 300, a first memory 340, an image reception interface 310, and a printer interface 302. In yet another alternative example embodiment, the image processing subsystem further comprises a cutter interface 330.

This first example embodiment also includes a memory 340 that is used to store datum and one or more instruction sequences. Further included in this example embodiment are various functional modules each of which comprises an instruction sequence. For purposes of this disclosure, a functional module and its corresponding instruction sequence is referred to by a process name, a function name or a module name, each of which may be used interchangeably. The instruction sequence that implements a particular named process, according to one alternative embodiment, is stored in the memory 340. The reader is advised that the term “minimally causes the processor” and variants thereof is intended to serve as an open-ended enumeration of functions performed by the processor 300 as it executes a particular functional process (i.e. instruction sequence). As such, an embodiment where a particular functional process causes the processor to perform functions in addition to those defined in the appended claims is to be included in the scope of the claims appended hereto. In this first example embodiment, the image processing subsystem 205 includes an image job processing module 345 that is stored in the memory.

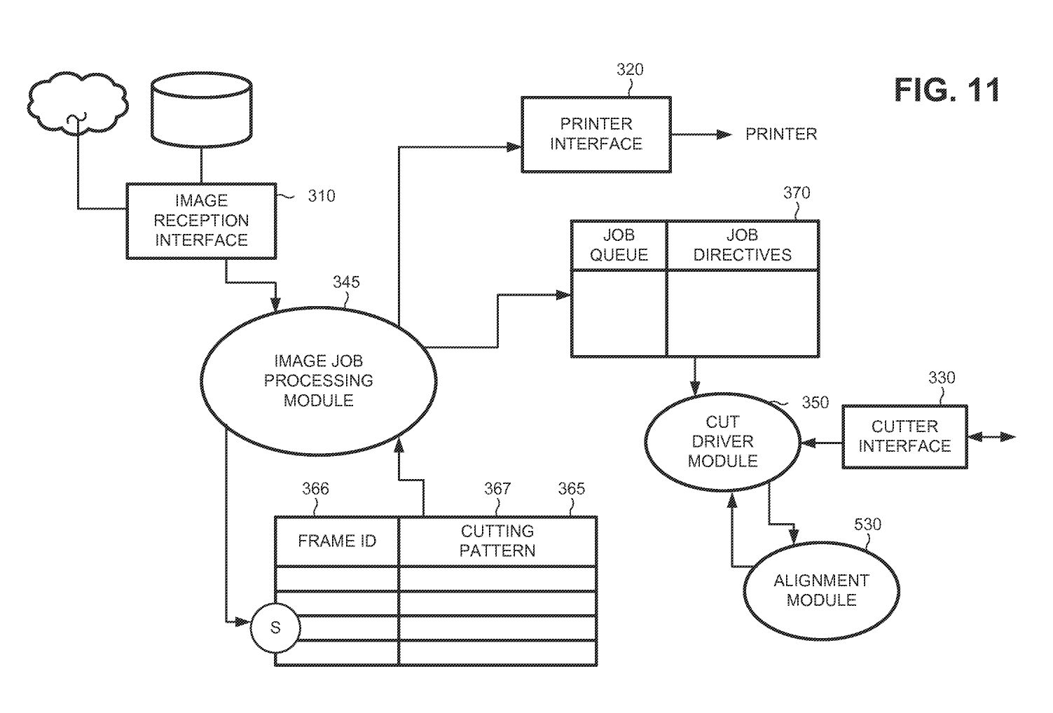

FIG. 11 is a dataflow diagram that depicts the internal operation of an image processing subsystem. In this example embodiment, the image processing module 345, when executed by the processor 300, minimally causes the processor 300 to receive a first image by way of the image reception interface 310. The image job processing module 345 of this example embodiment further minimally causes the processor 300 to receive a first frame style directive which is associated with the first received image. The processor 300, as it continues to execute this example embodiment of the image processing module 345, further minimally generates a printing script that is then directed by the processor 300 to the printer interface 320. In this example embodiment, the image job processing module 345 minimally causes the processor to generate a printing script that includes at least one of a job descriptor, a cut directive and a placement directive according to the teachings of the present method.

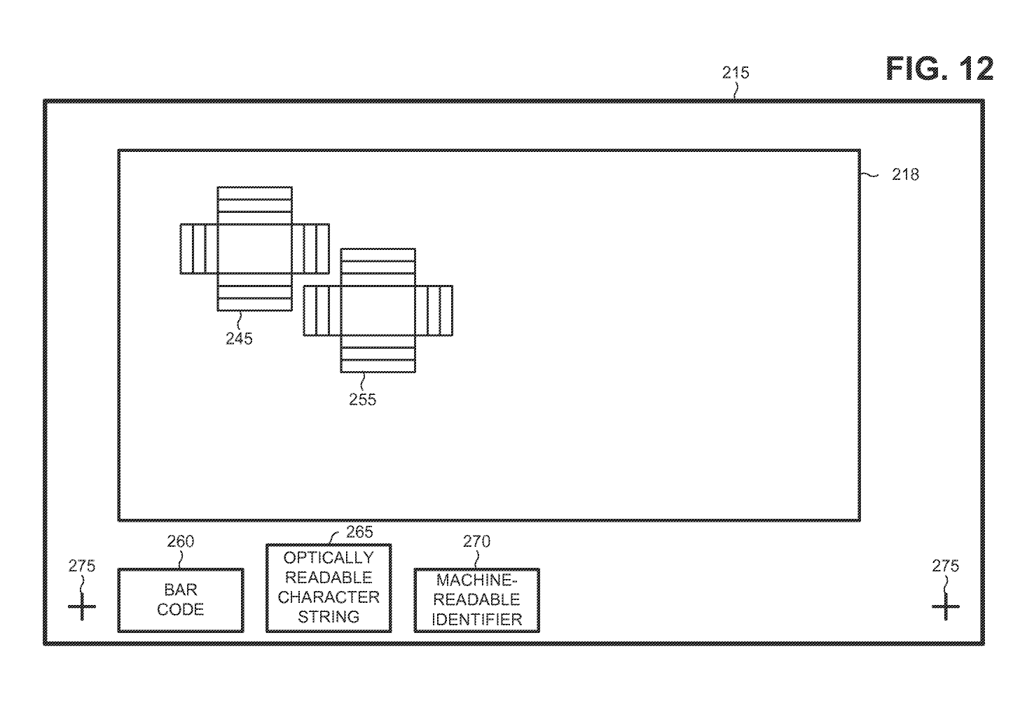

FIG. 12 is a pictorial representation that depicts how images are imparted upon a substrate. It should be appreciated that the processor 300, as it executes one alternative example embodiment of an image job processing module 345, is further minimally caused to generate a printing script that includes print commands to impart one or more images onto the first surface of the substrate 215. For example, a first image 245 is imparted onto the substrate 215 within a particular area 218. It is to be appreciated that this first image 245 includes not only a first image in electronic format received from a user but also a setback for a frame template. It should also be appreciated that the frame template need not necessarily be printed but rather there must be a setback to accommodate the frame template relative to a second image 255 and its associated frame template within the area 218 to be printed. An image together with an associated frame template is referred to as a virtualized framed image.

The processor 300, as it continues to execute this example embodiment of an image processing module 345, is further minimally caused to create a cut directive according to the frame template and the first image imparted to substrate 215. In yet another alternative example embodiment, the processor 300, as it continues to execute the image job processing module 345, is further minimally caused to included placement directive is in the print script. In one alternative example embodiment, a placement directive includes registration marks 275 which are printed along with the image imparted up to the substrate 215 within the print area 218. However, the registration marks 275 are not necessarily within the print area 218 and are typically in a substantially pre-specified location near opposite corners of the substrate 215.

And in yet another alternative example embodiment, the image job processing module 345 further minimally causes the processor 300 to create a job identifier within the print script that includes at least one of a bar-code 260 and an optically readable character string 265. In this alternative embodiment, the job identifier may also be embodied as any suitable machine-readable identifier 270.

And in yet another alternative example embodiment, the image job processing module 345 further minimally causes the processor 300 to create a cut directive by including within the print script at least one of a bar-code 260 and an optically readable character string 265. In this alternative embodiment, the cut directive may also be embodied as any suitable machine-readable identifier 270.

FIG. 11 further depicts that the processor 300, as it executes one alternative example embodiment of an image job processing module 345, creates a printing script by a first retrieving a frame template from the memory 340. It to be appreciated that the frame template to stored in a frame table 365. It should be appreciated that every entry into frame table 365 includes a frame identifier field 366 and a cutting pattern 367. Accordingly, a frame template is selected according to the frame directive received contemporaneously with and thus associated with the received electronic form of a first image. Once an entry in the frame table 365 has been selected, a cutting pattern is retrieved flora the cutting pattern field of that entry 366. The retrieved cutting pattern is then use by the processor 300 to create a cut directive for the frame as it is associated with the first image. The cutting pattern is optionally offset by the processor 300 to the area 218 on the substrate 215.

According to yet another alternative example embodiment, the image job processing module 345, when executed by the processor 300, further minimally causes the processor 300 to receive a second image by way of the image reception interface 310. The processor is also further minimally caused to receive a second frame directive. Using the second frame directive, the processor retrieves a frame template from the frame table 365. Accordingly, the processor 300 in this alternative example embodiment is further minimally caused to create to a plurality of virtualized framed images using the first and second images and the first and second frame templates according to the teachings of the present method.

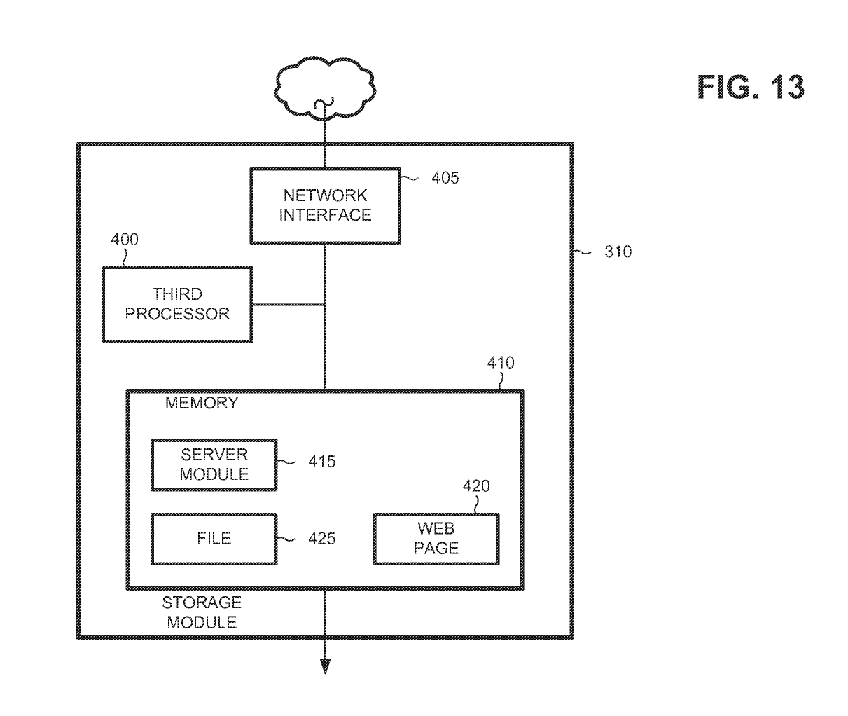

FIG. 13 is a block diagram that depicts an example alternative embodiment of an image reception interface. According to this alternative example embodiment, and image reception interface 310 comprises a network interface 405, a third processor 400 and a memory 410. One or more instruction sequences are stored in the memory 410 including a Web server module 415. In this alternative embodiment, the third memory 410 is used to store a web page 420 and to store an image 425 that is received by way of the network interface.

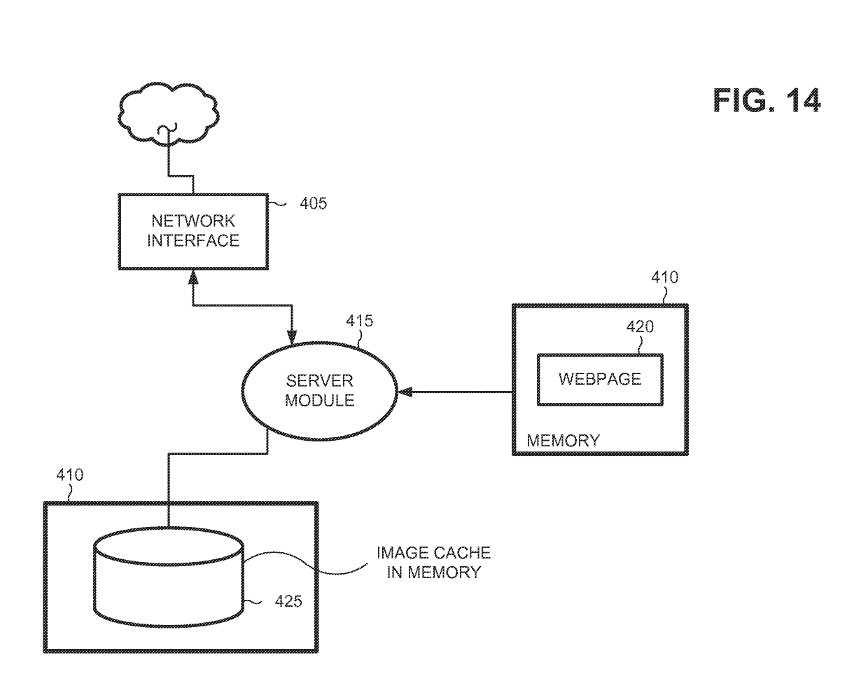

FIG. 14 is a dataflow diagram that depicts the operation of one alternative example embodiment of an image reception interface. In this alternative example embodiment, the third processor 400, when executing this server module 415, is minimally caused to receive a request for a web page by way of the network interface 405. In response to the request for a web page, server module 415, when executed by the third processor 400, further minimally causes the processor 400 to retrieve a web page 420 from the memory 410 and to direct said web page to the network interface 405. In this alternative example embodiment, the web page 420 includes a file upload element. Accordingly, when a user selects a file and then directs the file to the network interface 405, the server module 415, when execute by the third processor 400, further minimally causes the third processor 400 to receive the file by way of the network interface 405 and to store the file in the memory 425.

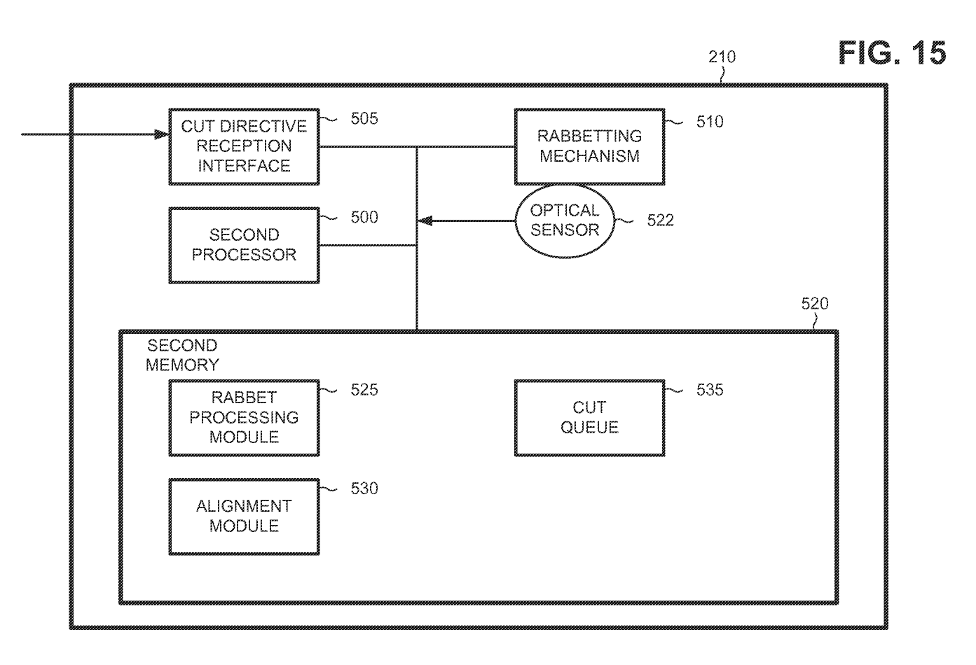

FIG. 15 is a block diagram that depicts one example embodiment of the substrate rabbetting subsystem. According to this example embodiment, the rabbetting subsystem 210 comprises a second processor 500, a second memory 520, a cut directive reception interface 505, a rabbetting mechanism 510 and one or more instruction sequences stored in the memory 520 including a rabbetting processing module 525. The second memory 520 is also used to store datum including a cut queue 535. In yet another alternative embodiment, the second memory 520 is also used to store an alignment module 530.

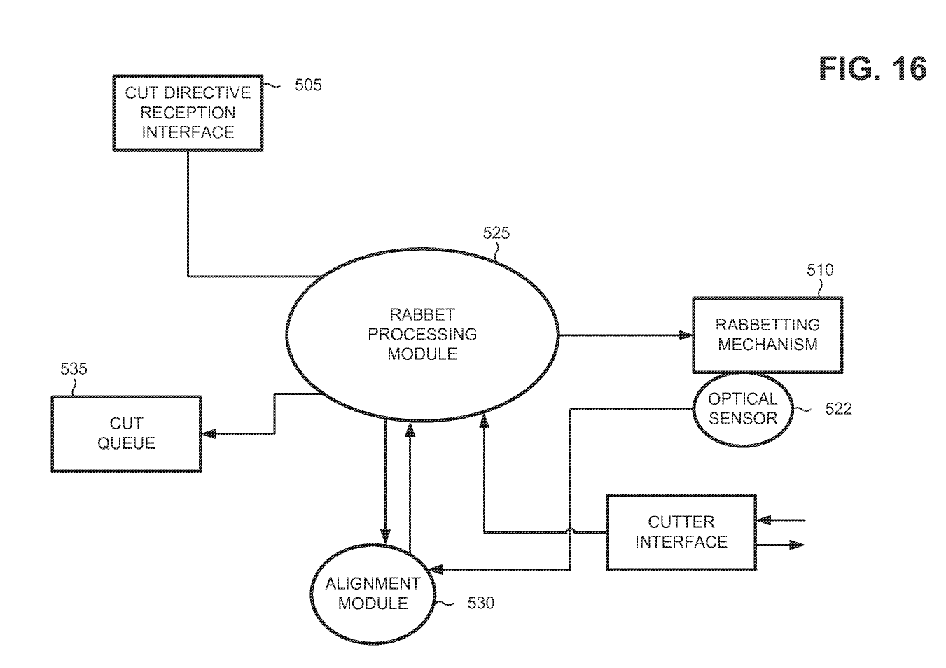

FIG. 16 is a dataflow diagram that depicts the operation of one example embodiment of a rabbetting subsystem. In this example embodiment, the rabbetting processing module 525, when executed by the second processor 500, minimally causes the second processor 500 to receive a cut directive by way of the cut directive reception interface 505. In this example embodiment, the processor 500 is further minimally caused to receive a cut directive in the form of at least one of a job descriptor, a cut directive and the placement directive. It should be appreciated that the rabbetting mechanism 510 is then operated according to the received cut directive.

And in one alternative example embodiment, the second processor 500, while executing the rabbetting processing module 525, further begins to execute the alignment module 530. In this alternative example embodiment, the rabbetting subsystem 210 further includes an optical sensor 522 disposed so as to perceive alignment/registration marks that have been printed upon a substrate. Using the perceived alignment/registration marks, the alignment module 530, when executed by the processor 500, minimally causes the processor to adjust the alignment of a cut directive according to the registration marks on the substrate as perceived by the optical sensor 522.

In one alternative embodiment, the rabbet processing module 525, when executed by the second processor 500, further minimally causes the processor 500 to direct cut directives to an external cutter by way of a cutter interface 511 included in this alternative embodiment of the rabbeting subsystem.

The functional processes (and their corresponding instruction sequences) described thus far enable manufacture of rigid framed images in accordance with the teachings of the present method. According to one alternative embodiment, these functional processes are imparted onto computer readable medium. Examples of such medium include, but are not limited to, random access memory, read-only memory (ROM), Compact Disk (CD ROM), Digital Versatile Disks (DVD), floppy disks, flash memory, and magnetic tape. This computer readable medium, which alone or in combination can constitute a stand-alone product, can be used to convert a general, or special purpose computing platform into an apparatus capable of manufacturing rigid framed images according to the techniques and teachings presented herein. Accordingly, the claims appended hereto are to include such computer readable medium imparted with such instruction sequences that enable execution of the present method and all of the teachings afore described.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for automatically creating a rigid framed image comprising:
receiving a first image in an electronic form;
receiving a first frame style directive for the first received image;
generating a printing script according to the first image and the first frame style directive wherein the printing script includes at least one of a job descriptor, a cut directive and a placement directive;
directing the printing script to a printer;
reading at least one of a job descriptor, a cut directive and a registration directive from an image substrate wherein the substrate has been printed by the printer;
cutting grooves into the back of the substrate according to at least one of the job descriptor, the cut directive and the registration directive read from the substrate.

2. The method of claim 1 wherein receiving a first image comprises:
receiving a request for a web page;
providing a web page in response to the request wherein said web page includes a file upload element; and
storing a first image received by means of the file upload element.

3. The method of claim 1 wherein generating a printing script comprises:
creating a job identifier using at least one of a bar code, an optically readable character string and a machine readable image; and
incorporating the job identifier in the printing script.

4. The method of claim 1 wherein generating a printing script comprises:
creating a cut directive using at least one of a bar code, an optically readable character string and a machine readable image; and
incorporating the cut directive in the printing script.

5. The method of claim 1 wherein generating a printing script comprises:
attaching a first frame template to the first image;
associating the first image and the first frame template with a substrate area;
creating a cut directive for the composite of the first image and the first frame template; and
incorporating the cut directive in e printing script.

6. The method of claim 1 wherein cutting grooves according a registration directive comprises:
optically perceiving the registration directive when the substrate is placed in position for cutting grooves;
determining an offset for the substrate relative a cutting mechanism according to the perceived registration directive; and
adjusting the cut directive according to the offset.

7. The method of claim 1 further comprising:
receiving a second image in an electronic form;
receiving a second frame style directive for the second image and wherein the step of generating a printing script comprises:
attaching a first frame template to the first image;
associating the first image and the first frame template with a substrate area;
attaching a second frame template to the second image;
associating the second image and the second frame template with the substrate area;
creating a cut directive according to the composite of the first and second images and the first and second frame templates; and
incorporating the cut directive in the printing script.

8. A system for fabricating a rigid framed image comprising:
image processing subsystem comprising:
first processor for executing one or more instruction sequences;
first memory for storing one or more instruction sequences;
image reception interface;
printer interface;
one or more instruction sequences stored in the first memory including:
image job processing module that, when executed by the processor, minimally causes the processor to:
receive a first image by way of the image reception interface;
receive a first frame style directive for the first received image;
create a virtualized framed image according to the first image and the first frame directive;
generate a printing script according to the virtualized framed image wherein said printing script includes at least one of a job descriptor, a cut directive and a placement directive; and
directs the printing script to the printer interface;
substrate rabbetting subsystem comprising:
second processor for executing one or more instruction sequences;
second memory for storing one or more instruction sequences;
cut directive reception interface;
rabbetting mechanism for imparting a rabbet into a substrate;
one or more instruction sequences stored in the second memory including:
rabbet processing module that, when executed by the processor, minimally causes the processor to:
receive a cut directive by means of the cut directive reception interface wherein the cut directive includes at least one of job descriptor, a cut directive and a placement directive; and
operate the rabetting mechanism according to the cut directive.

9. The system of claim 8 wherein the image reception interface comprises:
network interface;
third processor for executing one or more instruction sequences;
third memory for storing one or more instruction sequences; and
one or more instruction sequences stored in the third memory including:
a web server module that, when executed by the third processor, minimally causes the third processor to:
receive a request for a web page by way of the network interface;
direct a web page to the network interface in response to the request for a web page, said web page including a file upload element; and
receive an image by way of the network interface.

10. The system of claim 8 wherein the image job processing module minimally causes the processor to create a job identifier by minimally causing the processor to generate a print script that includes printing scripts for at least one of a bar code, an optically readable character string and a machine readable identifier.

11. The system of claim 8 wherein the image job processing module minimally causes the processor to create a cut directive by minimally causing the processor to generate a print script that includes printing scripts for at least one of a bar code, an optically readable character string and a machine readable identifier.

12. The system of claim 8 wherein the image job processing module minimally causes the processor to create a printing script by minimally causing the processor to:
retrieve a frame template from the memory according to the first frame style directive;
retrieve the first image from the memory;
associate the frame template and the first image with a print area on a substrate;
create a cut directive according to the frame template and the first image; and
incorporate the cut directive into a printing script.

13. The system of claim 8 further comprising an optical sensor and an alignment module that is stored in the second memory an optical sensor and wherein the rabbet processing module causes the second processor to operate the rabetting mechanism by minimally causing the processor to execute the alignment module that, when executed by the second processor, minimally causes the second processor to:
perceive a registration mark on a substrate using the optical sensor; and
generate an offset directive for a cut directive according to the registration mark;
and wherein the second processor continues to execute the rabbet processing module that, when executed by the second processor, further minimally causes the second processor to:
operate the rabetting mechanism according to the cut directive and according to the offset directive.

14. The system of claim 8 wherein the image job processing module, when executed by the first processor, further minimally causes the first processor to:
receive a second image by way of the image reception interface;
receive a second frame style directive by way of the image reception interface;
and wherein the processor creates a virtualized framed image according to the first and second images and the first and second frame directives.
